(19) United States
(12) Patent Application Publication
(10) Pub. No.: US 2026/0306228 A1
(43) Pub. Date: Oct. 8, 2026

(54) Touchless Faucet with Integrated Flosser

(71) Applicant: Tony Selimi, Cape Coral, FL (US)

(72) Inventor: Tony Selimi, Cape Coral, FL (US)

(21) Appl. No.: 19/640,301

(22) Filed: Apr. 6, 2026

Related U.S. Application Data
(60) Provisional application No. 63/783,773, filed on Apr. 4, 2025.

(51) Int. Cl. A61C 17/032; E03C 1/04; E03C 1/05

(52) U.S. Cl. CPC A61C 17/032; E03C 1/0405; E03C 1/057

(57) ABSTRACT

A touchless faucet with integrated flosser includes a faucet assembly, a flosser assembly, a water supply system, and an electronic control system.

The current application claims a priority to the U.S. provisional patent application Ser. No. 63/783,773 filed on Apr. 4, 2025.

### FIELD OF THE INVENTION

The present invention generally relates to a sink. More specifically, the present invention is a touchless faucet with a retractable water flosser integrated into the faucet.

### BACKGROUND OF THE INVENTION

Touchless faucets have become increasingly common in both residential and commercial settings due to their hygienic advantages, water conservation benefits, and ease of use. These faucets typically operate via motion sensors, allowing water to flow automatically when a user's hands are detected beneath the spout. While this technology has advanced in recent years to include temperature and flow rate controls via gestures or touch-sensitive interfaces, it remains primarily limited to basic hand-washing functionality.

Similarly, water flossers, also known as oral irrigators, have emerged as an effective tool in personal dental hygiene. These devices employ a focused stream of pressurized water to dislodge food particles and plaque from between the teeth and below the gumline. Numerous clinical studies have validated their ability to reduce gingivitis and promote gum health when used in conjunction with, or as an alternative to, traditional string flossing. Water flossers typically exist as stand-alone countertop devices, requiring a separate reservoir, power source, and physical space on a sink or bathroom counter.

Despite the widespread adoption of both touchless faucets and water flossers, each system operates independently and with substantial redundancy in infrastructure. Most water flossers include an internal water pump, separate tubing, and proprietary water containers—components that replicate functionality already present in modern plumbing fixtures. This duplication not only increases the cost and complexity of ownership but also contributes to countertop clutter, inconvenience, and the potential for reduced user compliance with daily flossing routines. Users are required to manage two devices with overlapping functions, navigate multiple controls, and dedicate additional time and effort to oral care.

Furthermore, conventional water flossers typically lack the smart control and gesture-based inputs found in modern faucet systems. Likewise, most touchless faucets do not integrate any form of multi-functionality beyond handwashing. Thus, the current landscape of faucet and oral hygiene technology presents a fragmented and inefficient user experience, particularly in smaller or shared living spaces.

In light of these limitations, there exists a need for an integrated solution that combines the hygienic benefits and convenience of a touchless faucet with the therapeutic functionality of a water flosser. Such a system should reduce redundancy, save space, streamline user interaction, and improve overall compliance with daily hygiene routines.

Accordingly, an objective of the present invention is to provide a touchless faucet system with an integrated flosser that consolidates water control, oral hygiene functionality, and user interface into a single, cohesive unit. The present invention seeks to eliminate the need for a separate countertop flosser while leveraging the same water supply and electronic control infrastructure already present in advanced faucet systems.

Another objective of the present invention is to enable intuitive control of both faucet and flosser functions through motion sensors, display screens, and toggle switches, thereby enhancing ease of use and minimizing physical contact with the device—an especially important feature in medical, hospitality, and food preparation environments where hygiene is critical.

A further objective is to provide precise control over water temperature and pressure for both the faucet and flosser through a responsive electronic control system. By integrating temperature and pressure sensors, electronic ball valves, and a smart controller, the system ensures a consistent and customizable user experience across both functions.

Additionally, the present invention aims to reduce clutter and improve the aesthetic appeal of bathroom or kitchen spaces by housing the flosser within a recess of the faucet body, and by routing water through internal conduits shared with the faucet system. The invention offers a sleek, efficient, and sanitary solution that elevates personal hygiene while simplifying the overall design of sink areas.

### BRIEF DESCRIPTION OF THE DRAWINGS

FIG. 1 is a perspective view of the present invention.

FIG. 2 is a detailed perspective view of the present invention.

FIG. 3 is an alternate perspective view of the present invention.

FIG. 4 is a diagram of the faucet assembly and flosser assembly of the present invention.

FIG. 5 is a diagram if the faucet assembly and the at least one motion sensor thereof.

FIG. 6 is a detailed view of the faucet assembly and flosser assembly of the present invention.

FIG. 7 is a rear perspective view of the present invention showing the electrical control system and the water supply system thereof.

FIG. 8 is a detailed view of the electrical control system of the present invention.

FIG. 9 is an electrical diagram of the present invention.

FIG. 10 is a front view of the present invention.

FIG. 11 is a profile view of the present invention.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denote “at least one” but do not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of a touchless faucet with integrated flosser, embodiments of the present disclosure are not limited to use only in this context.

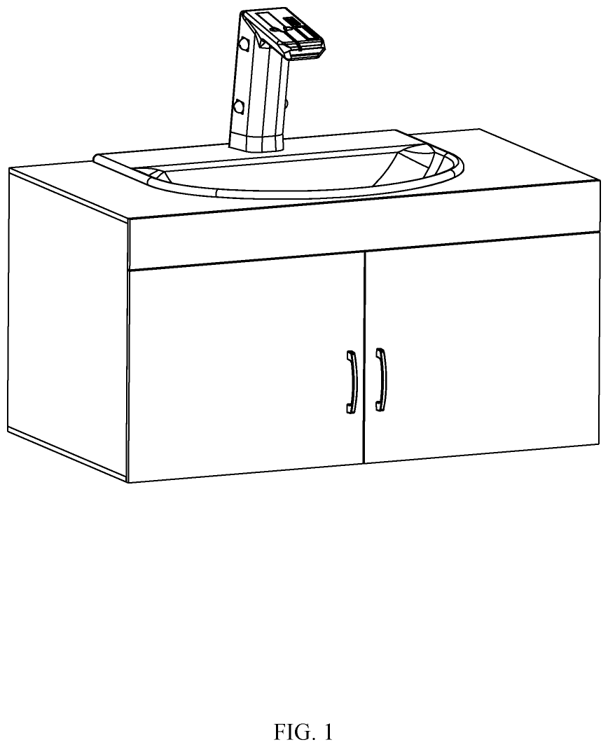

As shown in FIGS. 1-11, the present invention is a touchless faucet with integrated flosser comprising a faucet assembly, a flosser assembly, a water supply system, and an electronic control system. In the preferred embodiment of the present invention, flosser assembly is removably coupled to the faucet assembly. Furthermore, in the context of the present invention, the water supply system communicates water from an external water source, through the faucet assembly and the flosser assembly, wherein the water is expelled from the system. In the context of the present invention, the aforementioned “the system” and as mentioned herein, is intended to specify the claimed bounds of the present invention, such that the system (i.e. the present invention), receives water from an external system, and expels said water from said system. Additionally, in the context of the present invention, the electronic control system converts electronic signals to physical transformations (i.e. an electronic valve), thus facilitating communication of water through the water supply system, flosser assembly, and faucet assembly.

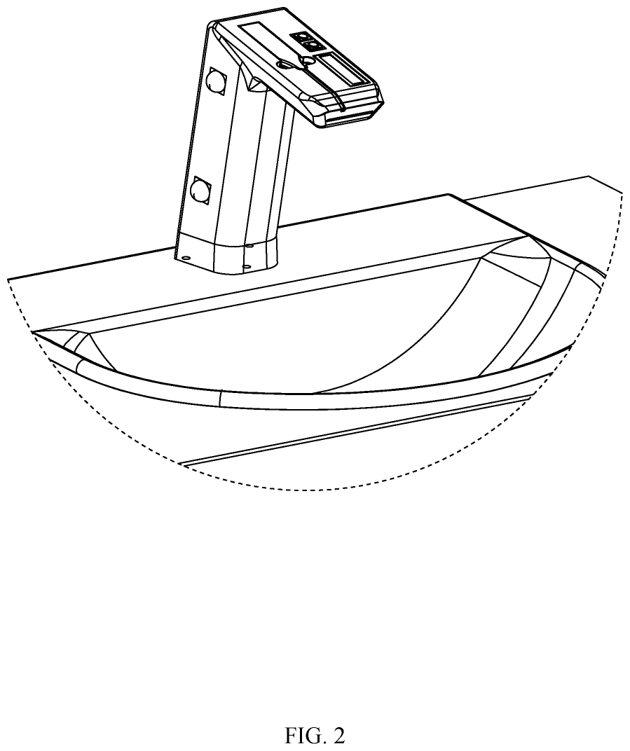

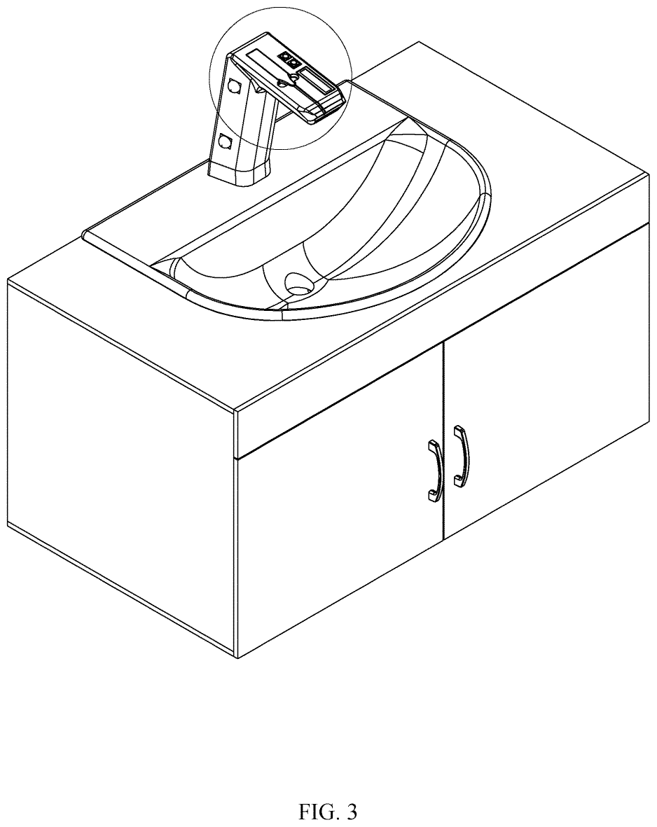

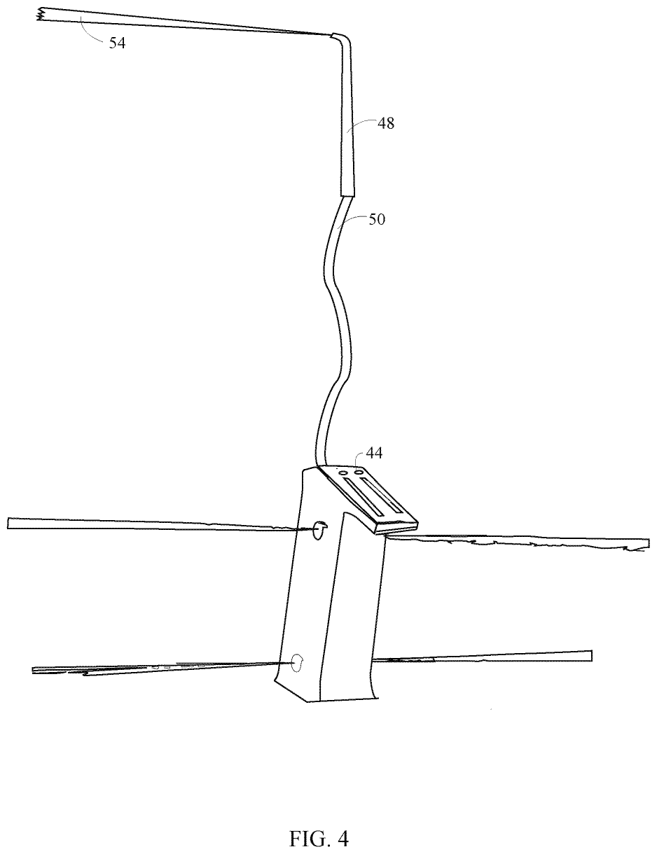

In the preferred embodiment of the present invention, as shown in FIGS. 2 and 3, the faucet assembly comprises a faucet body wherein said faucet body comprises a flosser recess wherein said flosser recess is a cavity wherein the flosser assembly is removably coupled. Furthermore, in the preferred embodiment of the present invention, the faucet body further comprises a user interface wherein said user interface comprises an at least one motion sensor, a display, and a toggle switch. In the context of the present invention, the toggle switch enables a user to selectively alter the system from expelling water through the faucet assembly or expelling water through the flosser assembly. In the preferred embodiment of the present invention, the flosser assembly comprises a flosser body and an outlet wherein the outlet expels water from the flosser body. In the context of the present invention, the flosser assembly is a device that uses a stream of pressurized water to clean between the teeth of a user, as shown in FIG. 4.

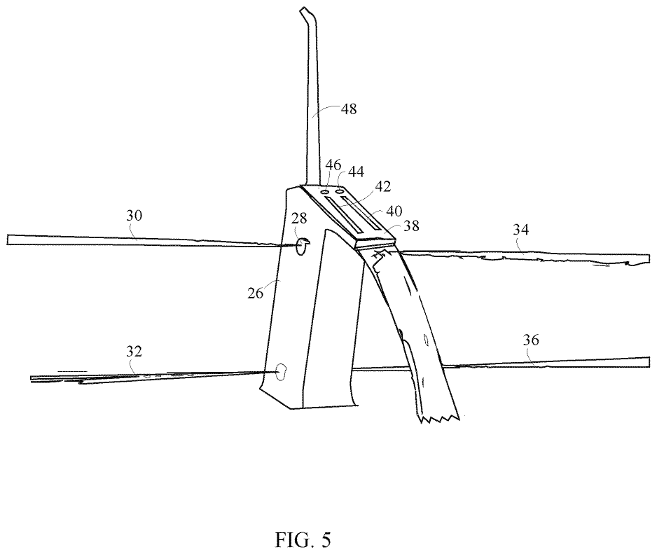

As shown in FIG. 5, in the context of the present invention, the at least one motion sensor comprises a plurality of motion sensors wherein said plurality of motion sensors comprises a first motion sensor wherein said first motion sensor enables the flow of water from the faucet assembly. Additionally, in the preferred embodiment of the present invention, the plurality of motion sensors comprises a first pair of motion sensors and a second pair of motion sensors wherein said first and second pairs of motion sensors are configured facing outwardly on opposing lateral sides of the faucet. In some embodiments of the present invention, the first pair of motion sensors would receive user input and facilitate user manipulation of temperature control. For example, in the aforementioned embodiment, variations in a user's hand position (i.e. raising and lowering of a user's hand) would generate an input, such that said inputs would be received by the first pair of motion sensors and transmit a signal to the electronic control system, thus varying the temperature of the water expelled from the faucet assembly. Likewise, in some embodiments of the present invention, the second pair of motion sensors would receive user input and facilitate user manipulation of pressure control. For example, in the aforementioned embodiment, variations in a user's hand position (i.e. raising and lowering of a user's hand) would generate an input, such that said inputs would be received by the second pair of motion sensors and transmit a signal to the electronic control system, thus varying the pressure of the water expelled from the faucet assembly.

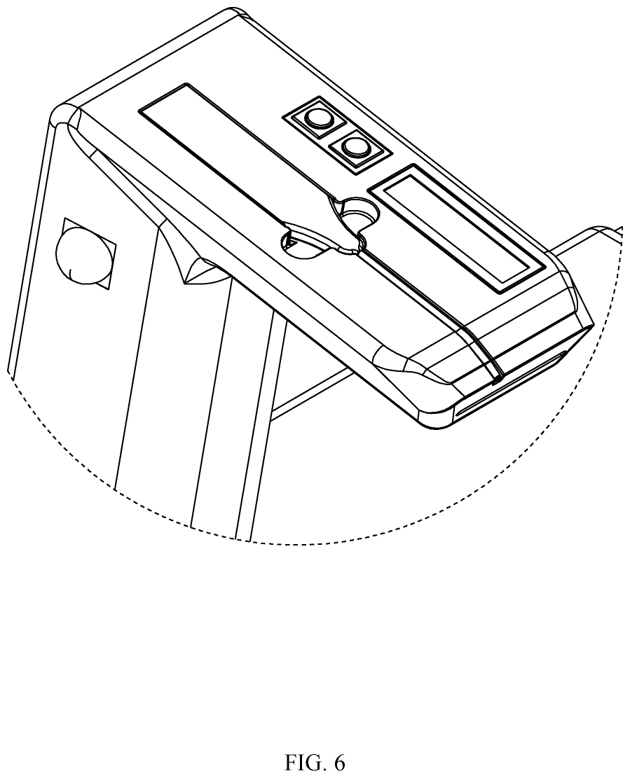

In the preferred embodiment of the present invention, as shown in FIG. 6, the display is a screen that generates visual outputs to the user. In the preferred embodiment of the present invention, the display is positioned on a topmost facing surface of the faucet body. Additionally, in some embodiments of the present invention, the display is a touch screen wherein said display receives user input.

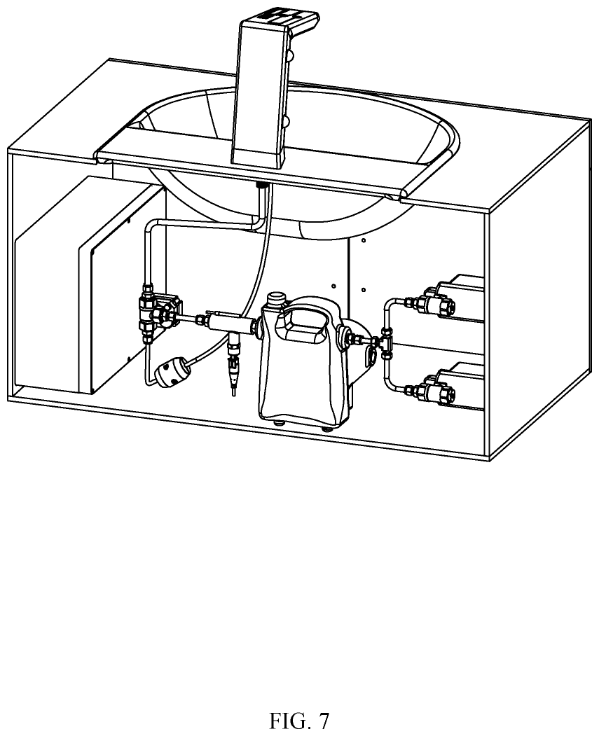

In the preferred embodiment of the present invention, as shown in FIG. 7, the water supply system comprises a hot-water intake, a cold-water intake, a water pump, a pressure sensor, and a temperature sensor. In the context of the present invention, the hot water intake and the cold-water intake are coupling by which hot water and cold water respectively, enter the system from an external water source. Additionally, in the context of the present invention, the water pump drives water through the water supply system from the hot and cold-water intakes until it is expelled. Further, the temperature sensor and the pressure sensor measure the respective variables and communicate signals to the electrical control system, indicative of said respective variables.

In the preferred embodiment of the present invention, water enters into the system through the hot and cold-water intakes, wherein said water is communicated through an electronically controlled ball valves, such that said ball valves vary the ratio of hot and cold water entering the system. In the preferred embodiment of the present invention, the ball valves are controlled through the electrical control system, such that user input signals received by the at least one motion sensor are transmitted and converted into electrical signals which manipulate the ball valves. Upon entering the system, the hot and cold water is communicated through converging conduits, thus mixing the hot and cold water. Once mixed, the water is communicated through the water pump wherein the temperature and pressure sensors measure the temperature and pressure of the water, respectively. The water is then diverted to either the faucet assembly or the flosser assembly, through a section of conduit, wherein the diversion of water is facilitated by a second electronic ball valve actuated by the toggle switch. In the preferred embodiment of the present invention, the section of conduit diverting the water to the flosser assembly, extends through the faucet body. Additionally, in the preferred embodiment of the present invention, the conduit diverting the water to the flosser assembly comprises a weight, such that said weight maintains a tensive force on said conduit.

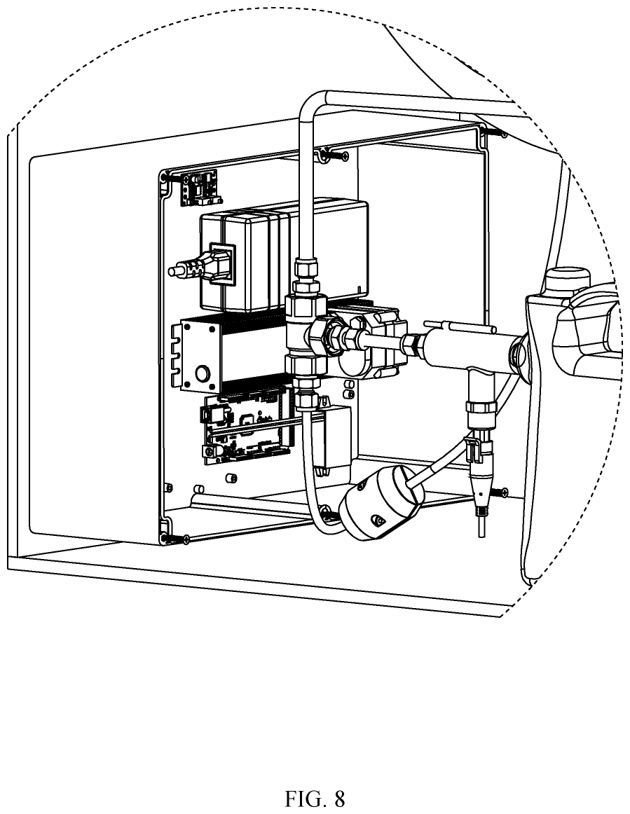

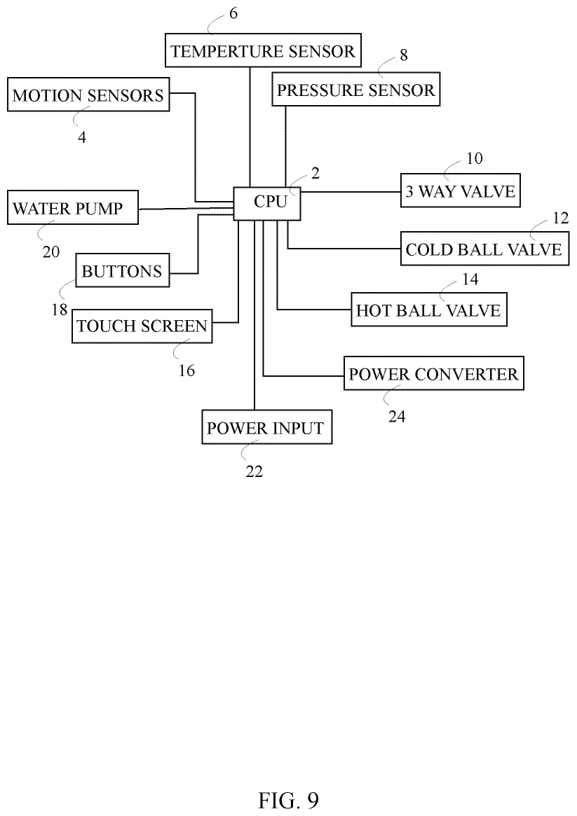

Furthermore, as shown in FIGS. 7 and 8, in the preferred embodiment of the present invention, the electrical control system comprises a main controller wherein said main controller executes computer readable methods. Furthermore, in the preferred embodiment of the present invention, the electrical control system further comprises a power input, a power converter, and a control generator. As shown in FIG. 9 in the preferred embodiment, the main controller transmits signals, receives signals, and executes computer readable methods to facilitate the operation of the temperature sensor, the pressure sensor, the electronically controlled ball valves, the power converter, the power input, the user interface, and the water pump. In the preferred embodiment of the present invention, the power input is a 24V power supply. Additionally, in the preferred embodiment of the present invention, the control generator is a 4-20 mA control generator.

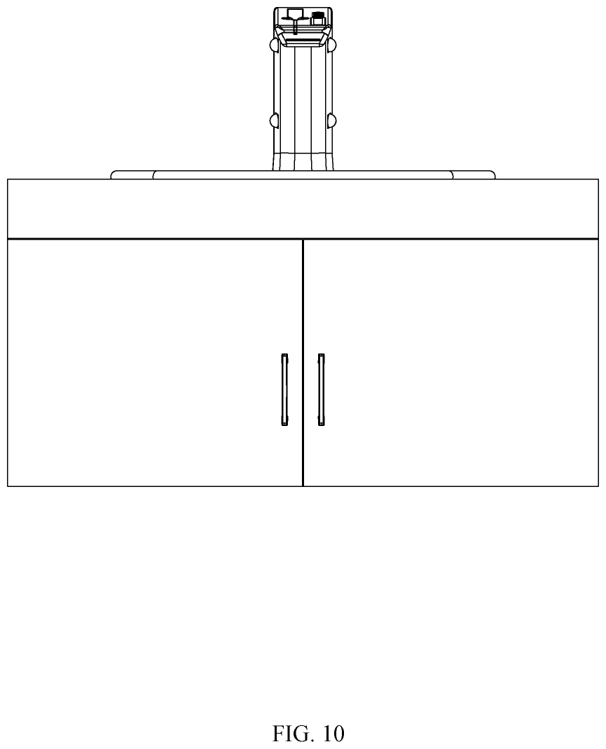

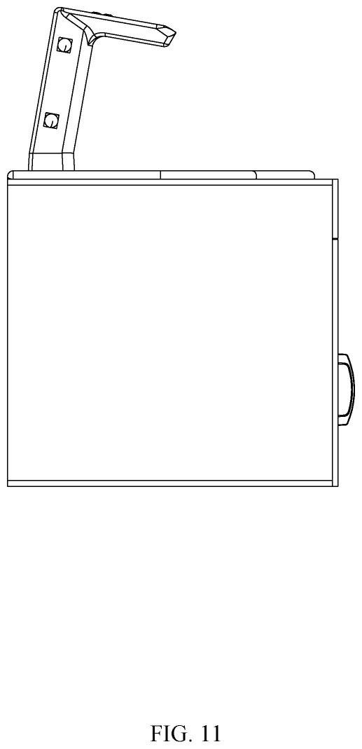

Furthermore, within the preferred embodiment of the present invention, as shown in FIGS. 10 and 11, the present invention is contained within a sink base cabinet or structure of the like wherein the electrical control system and the water supply system are contained within the sink base cabinet. Furthermore, within the preferred embodiment of the present invention, sink base cabinet further comprises a basin (i.e. a sink bowl), wherein the water expelled from the faucet assembly and the flosser assembly may be expelled into said basin.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

Although the invention has been explained in relation to its preferred embodiment, it is to be understood that many other possible modifications and variations can be made without departing from the spirit and scope of the invention.

What is claimed is:

1. A touchless faucet with integrated flosser comprising:
a faucet assembly;
a flosser assembly;
a water supply system;
an electronic control system;
the faucet assembly, the flosser assembly, and the water supply system being configured to combine hygienic, therapeutic, and convenience benefits of a touchless faucet with a water flosser; and
the electronic control system being electronically connected to the faucet assembly, the flosser assembly, and the water supply system.
